(19) United States
(12) Patent Application Publication
(10) Pub. No.: US 2003/0083028 A1
(43) Pub. Date: May 1, 2003

(54) Remote programming of radio preset stations over a network

(76) Inventor: Charles G. Williamson, Columbia, MO (US)

Correspondence Address: SONNENSCHEIN NATH & ROSENTHAL, Sears Tower, Wacker Drive Station, P.O. Box 061080, Chicago, IL, 60606-1080, US

(21) Appl. No.: 10/001,260

(22) Filed: Nov. 1, 2001

(51) Int. Cl. H04B 1/18

(52) U.S. Cl. 455/186.1; 455/185.1; 455/179.1

(57) ABSTRACT

The invention may be broadly conceptualized as an approach in which the configuration of a radio (108) occurs by a user entering data into a graphical interface (110), the data is stored in a user profile (112) at a server (106) and also downloaded to the radio (108).

### BACKGROUND OF THE INVENTION

1. Technical Field

The invention relates to configuring preset radio station in a radio. More particularly, the invention relates to configuring preset radio station remotely over a network.

2. Related Art

Currently, radio and stereo receivers may have a set of buttons assigned to preset radio stations. Whenever one of the buttons is selected, the tuner is automatically tuned to the preset station.

The mapping of the buttons to the preset radio stations is usually a manual process. The user tunes the tuner to a desired station and then assigns a button to correspond to the tuned station or frequency. Another approach to setting preset radio stations involves the tuner scanning all available stations and then using a selection criteria assign a stations to each of the buttons. Examples of selection criteria include the signal strength, type of music and selected frequency band.

A problem exists with the current approaches to defining preset radio stations. If the power is lost, the assignments of the preset radio stations are lost. The user is then required to assign the buttons to the desired radio stations again.

Thus, there is a needed in the art for an approach to assign preset radio stations that are easily restored if power is lost.

### SUMMARY

An intelligent appliance with a selector, such as a plurality of buttons is assigned preset radio stations connected to a network such as the Internet and configured by accessing a remote graphical user interface. The remote graphical interface configures a user profile in a database that maps the plurality of buttons to radio stations. If the radio is a clock radio, then the user associates a plurality of alarms with radio stations or “buzz” in the user profile. The user profile configuration data is transmitted to the radio upon being energized and upon changes occurring in the user profile. The radio then processes the received configuration data and configures the radio.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a diagram of a network that connects a web device with a server and radio in accordance with an embodiment of the invention.

FIG. 2 is a block diagram of the server 106 and radio 108 of FIG. 1 communicating across network 102.

FIG. 3 is a screen diagram of a graphical interface displayed on the web device of FIG. 1.

FIG. 4 is a screen diagram of another graphical interface displayed on the web device for configuring the alarms of the radio of FIG. 1.

FIG. 5 is a data structure in the user profile that is stored in the database on server 106 of FIG. 1.

FIG. 6 is a flow chart of a process for remote programming of radio presets over a network in accordance with an embodiment of the invention.

### DETAILED DESCRIPTION OF THE EXEMPLARY EMBODIMENTS

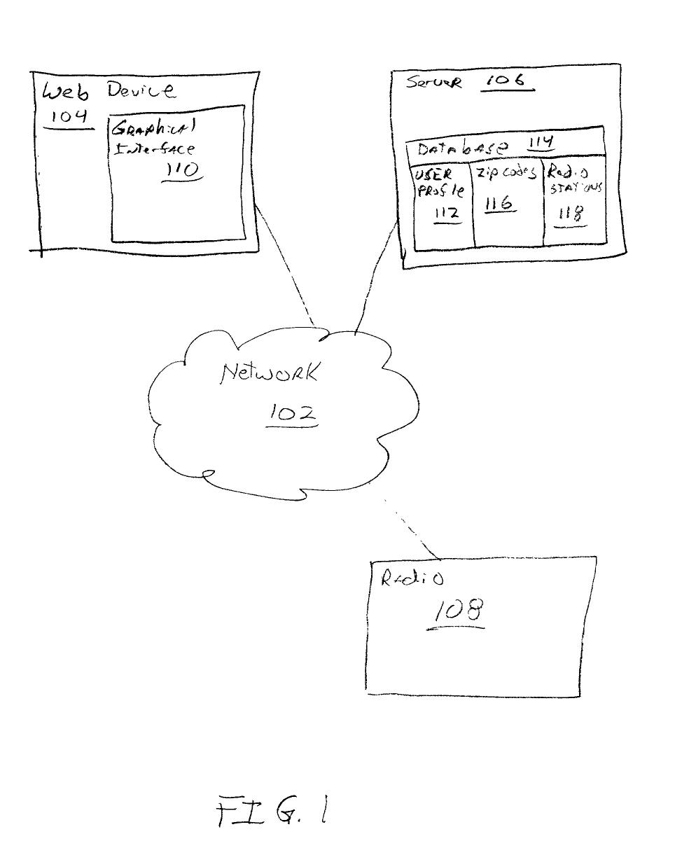

Reference is now made in detail to an embodiment of the present invention, an illustrative example of which is depicted in the accompanying drawings, showing an approach for remote programming of radio presets over network. In FIG. 1, a diagram of a network 102 that connects a web device 104 with a server 106 and radio 108.

The network 102 is a collection of hardware and software that make up one or more networks that enable the transportation of data between the web device 104, the server 106 and a communication link to radio 108. Examples of such networks include the public switch telephone network (PSTN), packet data networks, wireless data network, wireless cellular networks, X-10 networks and other in home networks, and 900 MHz wireless networks. Thus, network 102 may be comprised of a PSTN network that is wired between the web device 104 and server 106, while having a power line communication path between the radio 108 and a controller (not shown) in network 102.

The web device 104 is a second network device and is able to display the graphical interface 110. The graphical interface 110 is a web browser such as MICROSOFT's INTERNET EXPLORER or NETSCAPE. Examples of other types of graphical interfaces included ASCII text, graphics, combination of text and graphics, or a terminal emulation program. The web device 104 is a computing device that is able to display web pages that include a combination of text and graphics encoded in a mark up language such as HTML.

The graphical interface 110 resides on the web device 104 and a web page is downloaded to web device 104 upon the web address being accessed at the server 106 by the graphical interface 110. The user is prompted by the graphical interface to enter a location identifier and radio identifier into the graphical interface. The location identifier is some information, such as a zip code or city and state that indicates the geographical deployment of the radio. The radio identifier is a unique code associated with the physical radio. The location identifier and radio identifier are then sent to the server 106 by graphical interface 110 and stored in a user profile 112 assigned to the radio identifier in a database 114 operably associated with the server 106. In an alternate embodiment, the user will have a login identifier that is associated with the user profile 112 and the different radio identifiers will then be contained in that user profile 112.

The location identifier is associated with a plurality of radio stations in proximity of the identified location. In a preferred embodiment, the zip codes 116 are stored in the database 114 with each zip code being associated with a plurality of radio stations 118. The user is then presented another web page in the graphical interface 1 10 that allows the radio stations to be assigned to the preset buttons of radio 108. The assignments of the radio stations to the preset buttons are then stored in the user profile 112.

The server 106 is a first network device and manages the database 114. The server 106 is contacted by the radio 108 preferably upon the radio being energized. The radio 108 broadcasts (transmits) a message over the network that is received by the server 106. The broadcast message contains a radio identifier that is used by the database 114 to identify the associated user profile 112. In an alternate embodiment, the radio 108 has the address of server 106 and directly notifies the server 106 that the radio is present and sends the radio identifier to the server 106. The preset radio station mapping is downloaded from the server 106 to the radio 108 via network 102. In an alternate embodiment, a different identifier may be used that results in all radios attached to the network being downloaded with the preset radio stations. An example of such an address would be a users login name.

The downloading of the preset radio stations from the user profile 112 may also occur at predetermined time periods, such as every midnight or every Friday at midnight. The preset radio stations may also be downloaded upon an event occurring, such as the user profile being updated, the server 106 receiving an update request from the radio 108, the server 106 receiving an update request from the web device 104, or some other identifiable event occurring.

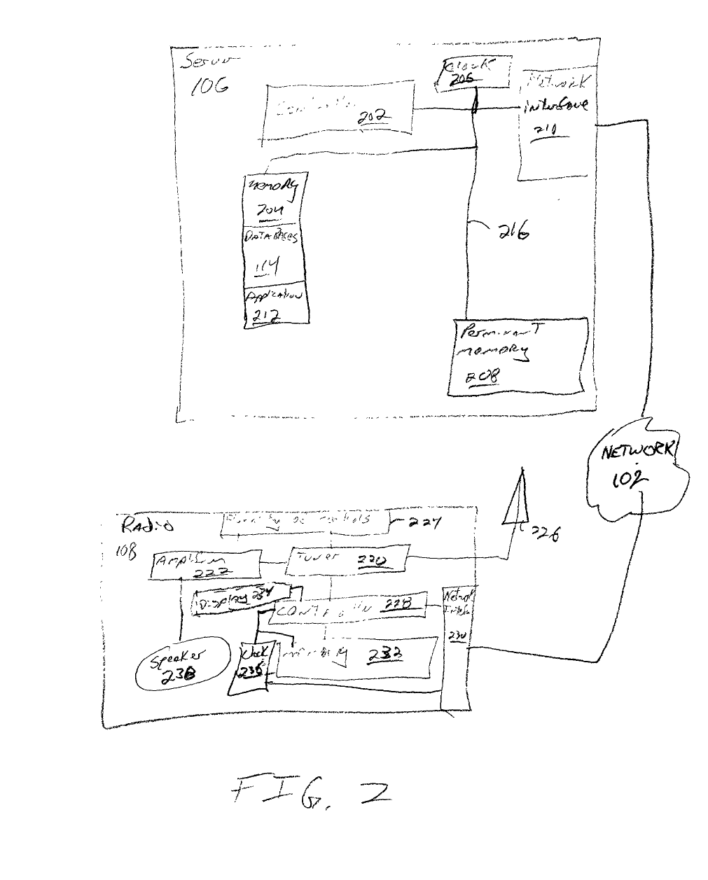

Turning to FIG. 2, a block diagram of the server 106 and radio 108 of FIG. 1 communicating across network 102 is shown. The server 106 is a computer device controlled by a controller 202. The controller 202 communicates with a memory 204, a clock 206, permanent storage 208, and a network interface 210. The controller 202 is a microprocessor such as an INTEL PENTIUM III processor. In an alternate embodiments, the controller may be a digital signal processor, embedded controller, discrete digital circuits functioning as a state machine, analog digital circuits functioning as a state machine, a combination of analog and digital components functioning as a controller. The controller 202 receives timing from a clock 206 that enables data to be transferred across bus 216.

The network interface 210 receives a message from the radio 108. The controller 202 under direction of an application 212 being executed from memory 204 processes the message and accesses the database 114 based on identification information contained in the message. In alternate embodiments, the database may reside in permanent memory 208 or in a combination of permanent memory 208 and memory 204. In other embodiments, it is possible for the database 114 to be distributed across multiple servers in a distributed database.

The controller 202 identifies the user profile 112 contained in database 114 and formats a configuration message. The configuration message contains the mapping of radio stations to the preset buttons in the radio 108. The configuration message is transmitted from the server 106 by the network interface 210 over network 102 to the radio 108.

The radio 108 has a tuner 220 that is connected to amplifier 222, a plurality of controls 224, an antenna 226, and a controller 228. The controller 108 is connected to tuner 220, network interface 230, memory 232, display 234 and clock 236. The clock supplies timing to the controller 228, the network interface 230 and the memory 232. The amplifier 222 is connected to the plurality of controls 224, the tuner 220 and at least one speaker 238 (stereo receivers often have two or more speakers).

The display 234 displays the current tuner setting, in other words the current radio station. In an alternate embodiment, the radio 108 is a clock radio and the display 234 displays the time and may display the date. In such an embodiment, the clock 236 may included a real-time clock for keeping track of time that is displayed by display 234.

The plurality of controls 224 are used to manually tune the radio and adjust the volume. A plurality of preset buttons also comprise at least part of the plurality of controls 224 that when set; will automatically tune the tuner 220 to a preset station. If the radio 108 is also a clock radio, then some of the plurality of controls 224 will be for manually setting the time. In an alarm clock radio embodiment, additional controls in the plurality of controls 224 will be present to arm/disarm the alarm, set the alarm to buzz or radio, and set the alarm time.

The tuner 220 tunes the radio 108 to a frequency in a amplitude modulated (AM) frequency band or a frequency modulated (FM) frequency band. In alternate embodiments tuners capable of receiving other or additional frequency bands may be used in place of the AM/FM tuner 220. The controller 228 on display 234 displays the setting of the tuner 220. The tuner 220 receives the radio signal at antenna 226 and demodulates the signal into an audio signal. The audio signal is amplified by amplifier 222 and heard at speaker 238.

In a preferred embodiment, the controller 228 formats the message upon the radio being energized. The message is sent by the network interface 230 across the network 102 to the server 106. In an alternate embodiment, the message is sent upon connection to the network 102 being detected by the network interface 230. The message from the radio 108 contains a radio identifier that is used to identify a record in database 114 at the server. A message containing the assignment of radio stations to the preset buttons is sent in a configuration message from the server 106 to the radio 108 over network 102.

The radio 108 receives the configuration message from the server 106 at the network interface 230. The configuration message is then processed by the controller 228. The controller configures preset radio stations in the tuner 220 that are associated with the preset buttons in the plurality of controls 224. Upon configuration of the preset radio stations, a user is able to select one of the preset buttons in the plurality of controls and the tuner 220 tunes to that radio station. Thus, the user does not have to reset their preset radio stations after the radio 108 is de-energized by a power outage, batteries going dead, or the radio being unplugged.

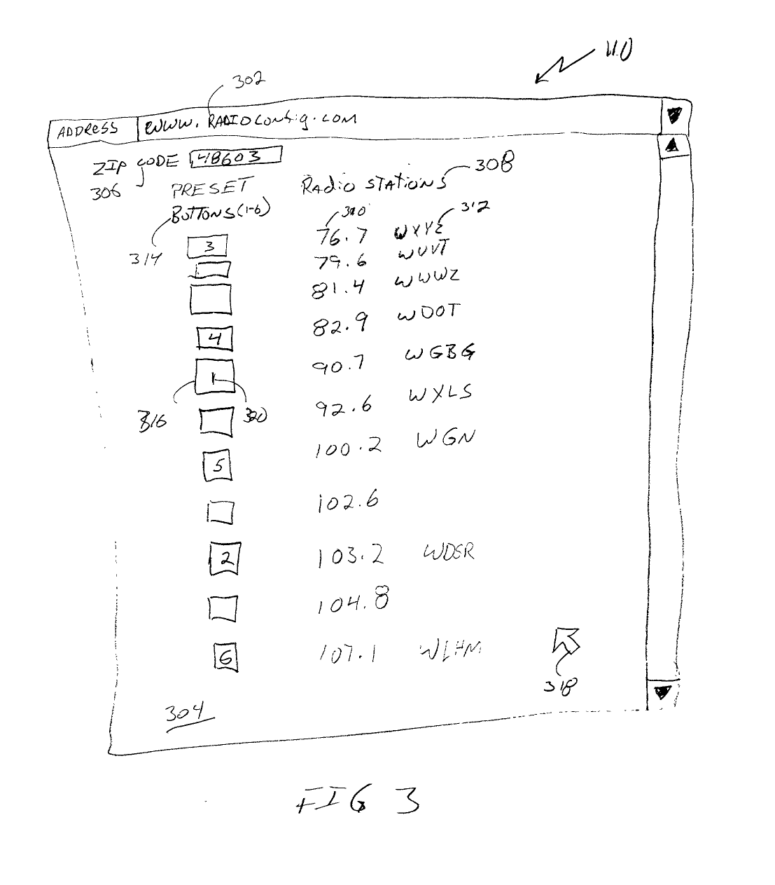

In FIG. 3, a screen diagram of one possible embodiment of the graphical interface 110 as displayed on the web device 104 of FIG. 1 is shown. The graphical interface 110 is a web browser that is displaying web page for configuring preset radio stations at a web address radioconfig.com 302. The web page for configuring preset radio stations is an association page that establishes an association list between a first set of configuration data and a second set of configuration data. The first set of configuration data is a plurality of preset button identifiers and the second set of configuration data is radio stations that may be assigned to the plurality of preset button identifiers.

The user had entered a location identifier 306 (zip code) in a previous page from which the list of local radio stations is generated and results in the radio configuration web page 304 being generated and sent from the server 106. The radio configuration web page 304 has the location identifier 306 and contains the list of local radio stations 308 each radio station will have a frequency displayed 310 and may have the radio call letters 312. In other embodiments, additional information such as radio station city, style of music or type of station (news or sports) may be displayed on the configuration web page 304. The user then is able to enter the preset button 314 by assigning numbers 1-6 to six radio stations 308. The user selects a box 316 using cursor 318 and enters the preset radio button number. A check is made as the user enters the preset radio button number 320 to verify that a number has not been used twice and only six radio stations 308 have been assigned preset radio button numbers.

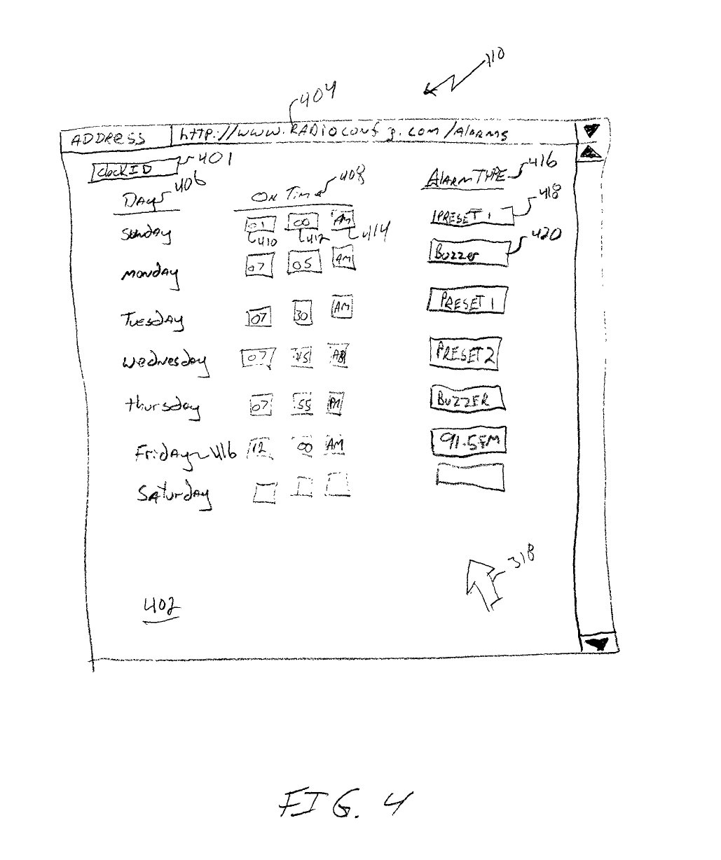

Turning to FIG. 4, a screen diagram of the graphical interface 1 10 displayed on the web device 104 for configuring the alarms of the radio 108 of FIG. 1 is shown. If radio 108 is an alarm clock, then a user may set the alarm times using the graphical interface 110 (web browser) and accessing an alarm configuration web page 402 by linking to the alarm configuration web page 402 from another page or by entering in the web address 404. The user may have to enter the clock ID 401 at the previous web page or a “cookie” may be present with a clock ID 401. The alarm configuration web page 402 is downloaded form a server 106 and displayed on web device 104 in the web browser 110.

The clock ID 401 associated with the clock that is being configured is displayed on the alarm web page. In addition, the day of week 406 and “on time” alarm settings 408 are also displayed in the alarm configuration web page 402 in web browser 110. Each day of the week 406 has an associated alarm setting 408, but in an alternate embodiment, multiple alarms may be configured on any day. The user using cursor 318 enters the hour 410, minute 412 and AM/PM 414 in a respective input box for each alarm that is sent. Each day of the week 406 is also associated with an alarm mode 416. The alarm mode identifies if the alarm is to be the radio preset station 418 or a buzzer 420. If an alarm is not set, then no information is placed in the hour/minute/AM/PM box such as for Friday 416.

The entered data is sent to the server 106 where it is placed in the user profile 112 in database 116. The alarm configuration information is then sent from the server 106 to the radio 108 over network 102. The controller 228 in the radio 108 then sets the alarms in the clock 236. It is possible that in some embodiments, the alarms will be set in the controller 228 In an alternate embodiment, the server 106 also sends a time synchronization message to the radio 108 that is a clock radio to set the clock.

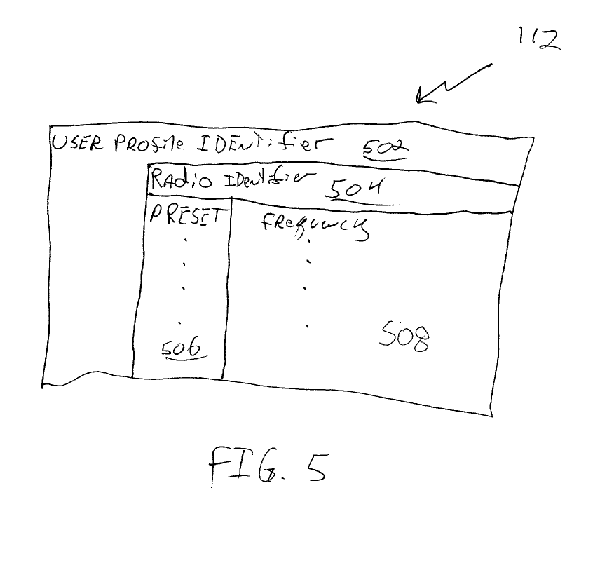

Turning to FIG. 5, a data structure in the user profile 112 that is stored in the database 114 on server 106 of FIG. 1 is shown. The user profile 112 is a record in database 114 that is stored in memory and is identified by a user profile identifier 502. The user profile identifier is linked to at least one radio identifier 504. In an alternative embodiment, the user profile identifier is the at least one radio identifier 504.

The radio identifier 504 has a link to a preset 506 identifier that is associated with a preset button on the radio. The preset 506 is linked to a frequency 508 that corresponds to a desired radio station. Only one radio identifier 504 is shown in FIG. 5, but in alternate embodiments, multiple radio identifiers may be present with each having a plurality of presets and frequencies. In yet another embodiment, only one radio identifier is used and all radios in a network or sub-network are configured with the same presets 506 and radio frequencies 508.

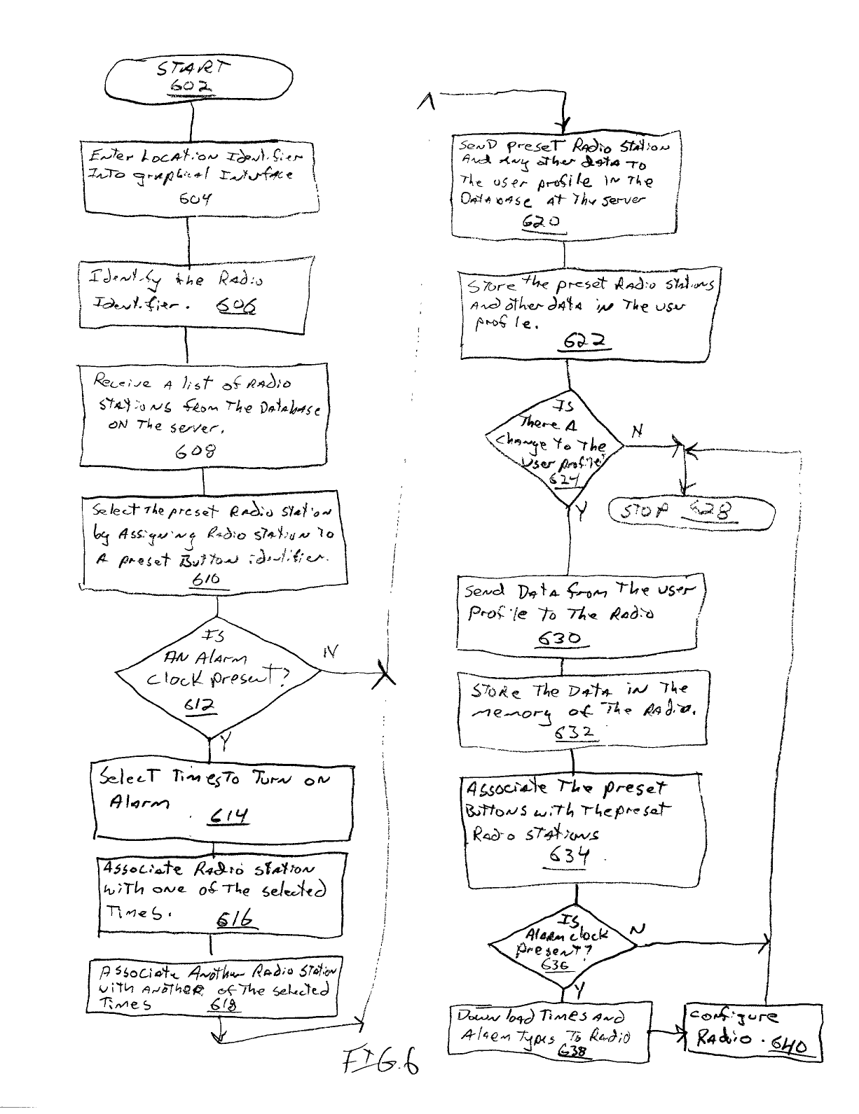

In FIG. 6, a flow chart of a process for remote programming of radio presets over a network 102 is shown. The process starts (602) when the user displaying a web page enters a location identifier into the graphical interface (604). The user has also provided a user identifier via logging into the server or by a “cookie” having been placed during a previous session. In response to the location identifier, the server 106 access the database 114 and identifies the radio identifier 504 in the user profile 112 (606) and the local radio stations contained in the radio station 118 part of the database. The list of radio stations is sent from the server 106 to the web device 104 (608). The user then selects the desired preset radio stations by assigning a preset button to each of the frequencies associated with the desired preset radio station (610). If a clock for displaying is not preset (612), then the preset radio stations and any other user profile data from the web page is sent to the server 106 (620) for storage in the user profile 112 of the database 114 (622).

If a clock for displaying time is present (612), i.e. radio 108 is a clock radio, then the alarm web page 404 is displayed and the user selects the alarm times (614). The selected alarm times are then associated with a radio frequency or left blank for a “buzz” alarm (616). Another alarm is then selected and associated with another radio frequency or left blank again for the “buzz” alarm (618). The alarm configuration information is then sent in addition to the preset radio stations from the web device 104 to the server 106 (620) where the data is stored in the user profile 112 in the database 114 (622). If the user profile in user profile is accessed by a web device 104 (624) and no change occurs, then processing is complete (628). If the user profile 112 has changed (624), then the data from the user profile 112 is sent to the radio 108 (630).

Upon receipt of the data from the user profile 112, the preset radio stations and the association with the preset buttons in the plurality of controls 224 is stored in the memory 232 of the radio 108 (632). Each of the preset buttons is associated by the controller 228 with a radio station as contained in the received association that was saved in memory 232 (634). When preset button is selected, the tuner will tune to the associated radio frequency that was contained in the association.

If the radio does not contain a clock (636), then processing is complete (628) and the radio is configured. If the radio does contain a clock (636), then the alarm time and alarm settings (radio or “buzz”) contained in the user profile 112 are sent from the server 106 to the radio 108 (638). The controller 228 in radio 108 receives the alarm time and the alarm settings and sets the alarm time and alarm settings (640). The configuration processing is then complete (628).

It is appreciated by those skilled in the art that the process shown in FIG. 15 may selectively be implemented in hardware, software, or a combination of hardware and software. An embodiment of the process steps employs at least one machine-readable signal-bearing medium. Examples of machine-readable signal bearing mediums include computer-readable mediums such as a magnetic storage medium (i.e. floppy disks, or optical storage such as compact disk (CD) or digital video disk (DVD)), a biological storage medium, or an atomic storage medium, a discrete logic circuit(s) having logic gates for implementing logic functions upon data signals, an application specific integrated circuit having appropriate logic gates, a programmable gate array(s) (PGA), a field programmable gate array (FPGA), a random access memory device (RAM), read only memory device (ROM), electronic programmable random access memory (EPROM), or equivalent. Note that the computer-readable medium could even be paper or another suitable medium, upon which the computer instruction is printed, as the program can be electronically captured, via for instance optical scanning of the paper or other medium, then compiled, interpreted or otherwise processed in a suitable manner if necessary, and then stored in a computer memory.

Additionally, machine-readable signal bearing medium includes computer-readable signal bearing mediums. Computer-readable signal bearing mediums have a modulated carrier signal transmitted over one or more wire based, wireless or fiber optic networks or within a system. For example, one or more wire based, wireless or fiber optic network, such as the telephone network, a local area network, the Internet, or a wireless network having a component of a computer-readable signal residing or passing through the network. The computer readable signal is a representation of one or more machine instructions written in or implemented with any number of programming languages.

Furthermore, the multiple process steps implemented with a programming language, which comprises an ordered listing of executable instructions for implementing logical functions, can be embodied in any machine-readable signal bearing medium for use by or in connection with an instruction execution system, apparatus, or device, such as a computer-based system, controller-containing system having a processor, microprocessor, digital signal processor, discrete logic circuit functioning as a controller, or other system that can fetch the instructions from the instruction execution system, apparatus, or device and execute the instructions.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

I claim:

1. A system to remotely configure a radio, comprising:
a graphical interface on a first network device that displays an association page that establishes an association list between a first set of configuration data with a second set of configuration data in a user profile in a remote database; and
a radio having a digital controller that is able to communicate with the remote database to retrieve and apply the user profile to facilitate operation of the radio.

2. The system of claim 2, wherein a plurality of preset button identifiers is the first set of configuration data; and
a plurality of radio stations is the second set of configuration data.

3. The system of claim 2, further comprising:
a preset button in a plurality of buttons located at the radio being associated with a radio station in response to receipt of the association list at the radio.

4. The system of claim 1, further comprising:
a location identifier identifies radio stations that are included in the first set of configuration data.

5. The system of claim 1, further comprising:
an alarm configuration page displayed in the graphical interface that establishes an alarm time list with an associated alarm type in the user profile.

7. The system of claim 6, wherein an alarm clock in the radio is sets in response to receipt of the alarm list and the associated alarm type from the user profile.

8. The system of claim 6, wherein receipt of a time synchronization message at the radio results in the alarm clock being set.

9. The system of claim 1, wherein the graphical interface is a web browser.

10. A method for remotely configuring a radio, comprising:
displaying on a graphical interface on a first network an association page that establishes an association list between a first set of configuration data with a second set of configuration data in a user profile in remote database; and
retrieving the user profile by a digital controller in the radio that is able to communicate with the remote database to facilitate the operation of the radio.

11. The method of claim 10, further comprising:
entering a location identifier at the graphical interface;
sending the location identifier to the remote database;
identifying the second set of configuration; and
receiving at least the second set of configuration data the first computing device.

12. The method of claim 10, further comprising:
generating a time synchronization message at the second computing device;
sending the time synchronization message to the radio; and
setting a clock in the radio in response to reception of the time synchronization message.

13. The method of claim 10, further comprising:
displaying an alarm configuration page in the graphical user interface;
creating an alarm association between an alarm action and a time of day;
storing the alarm association in the user profile located in the remote database; and;
communicating the alarm association to the radio.

14. The method in claim 10, wherein establishing further includes:
assigning a first present button identifier form a plurality of preset button that comprise the first set configuration data to a radio station from a plurality of radio stations that comprise the second set of configuration data.

15. The method of claim 14, wherein communicating further includes:
configuring a first preset button in a plurality of preset buttons in the radio to select the radio station upon the selection of the first preset radio button.

16. A data structure in a user profile located in a database, comprising:
a user profile identifier;
a plurality of preset button identifiers linked to the user profile identifier; and
an association between each of the plurality of preset button identifiers and one of a plurality of radio stations.

17. The data structure of claim 16, further comprising:
a plurality of alarm times linked to the user profile identifier; and
an alarm type linked to each of the plurality of alarm times.

18. The data structure of claim 17, wherein the alarm type is either a radio station or a buzz.

19. A system for remotely configuring a radio, comprising:
means for displaying on a graphical interface on a first network an association page that establishes an association list between a first set of configuration data with a second set of configuration data in a user profile in remote database; and
means for retrieving the user profile by a digital controller in the radio that is able to communicate with the remote database to facilitate the operation of the radio.

20. The system of claim 19, further comprising:
means for entering a location identifier at the graphical interface;
means for sending the location identifier to the remote database;
means for identifying the second set of configuration; and
means for receiving at least the second set of configuration data the first computing device.

21. The system of claim 19, further comprising:
means for generating a time synchronization message at the second computing device;
means for sending the time synchronization message to the radio; and
means for setting a clock in the radio in response to reception of the time synchronization message.

22. The system of claim 19, further comprising:
means for displaying an alarm configuration page in the graphical user interface;
means for creating an alarm association between an alarm action and a time of day;
means for storing the alarm association in the user profile located in the remote database; and
means for communicating the alarm association to the radio.

23. The system of claim 19, wherein the step establishing further includes:
means for assigning a first preset button identifier form a plurality of preset button that comprise the first set of configuration data to a radio station from a plurality of radio stations that comprise the second set of configuration data.

24. The system of claim 23, wherein the means for communicating further includes:
means for configuring a first preset button in a plurality of preset buttons in the radio to select the radio station upon the selection of the first preset radio button.
